(19) United States
(12) Patent Application Publication
(10) Pub. No.: US 2018/0201436 A1
(43) Pub. Date: Jul. 19, 2018

(54) Cartridge with Internal Liquid Flow Control Barriers

(71) Applicant: Christopher M. Savage, Woodbridge, VA (US)

(72) Inventor: Christopher M. Savage, Woodbridge, VA (US)

(21) Appl. No.: 15/870,963

(22) Filed: Jan. 14, 2018

Related U.S. Application Data
(60) Provisional application No. 62/446,649, filed on Jan. 16, 2017.

(51) Int. Cl. B65D 85/804; A23F 5/26

(52) U.S. Cl. CPC B65D 85/8046; A23F 5/262

(57) ABSTRACT

An apparatus comprises a cup, a lid, an injection zone, an evacuation zone, an upper barrier, and a lower barrier. The cup comprises a base and a sidewall rising from the base. The lid may be attached to a top of the sidewall. The injection zone is structurally configured to be pierceable by an injection needle. The injection zone is disposed in at least one of the sidewall and the lid. The evacuation zone is structurally configured to be pierceable by an evacuation needle. The evacuation zone is disposed in at least one of the sidewall and the base. The lower barrier comprises a pre-shaped portion surrounding the evacuation zone. The lower barrier comprises a periphery surrounding the pre-shaped portion. One or more attachment portions along the periphery are fastened to the cup. The upper barrier is positioned above the lower barrier and below the injection zone.

### CROSS-REFERENCE TO RELATED APPLICATIONS

This application claims the benefit of U.S. Provisional Application No. 62/446,649, filed Jan. 16, 2017, entitled “Solution Cartridge,” which is hereby incorporated by reference in its entirety.

### BRIEF DESCRIPTION OF THE SEVERAL VIEWS OF THE DRAWINGS

FIG. 1 is a system diagram of an example cartridge and a liquid flow controller as per an aspect of an embodiment of the present disclosure.

FIG. 2 is a block diagram of a cutaway view of an example cartridge as per an aspect of an embodiment of the present disclosure.

FIG. 3 is a block diagram of a cutaway view of an example cartridge showing a liquid flow as per an aspect of an embodiment of the present disclosure.

FIG. 4 is a block diagram of a cutaway view of an example cartridge showing a liquid flow as per an aspect of an embodiment of the present disclosure.

FIG. 5 is a block diagram of a cutaway view of an example cartridge showing a liquid flow and injection and evacuation needles as per an aspect of an embodiment of the present disclosure.

FIG. 6 is a block diagram of a cutaway side view of an example cartridge showing an evacuation needle as per an aspect of an embodiment of the present disclosure.

FIG. 7A and FIG. 7B are block diagrams of example barriers as per aspects of embodiments of the present disclosure.

FIG. 8A, FIG. 8B, FIG. 8C, and FIG. 8D are diagrams showing an example positions for the injection and evacuation needles as per aspects of embodiments of the present disclosure.

FIG. 9A, FIG. 9B, FIG. 9C, and FIG. 9D are diagrams showing an example placement of multiple liquid introduction areas as per aspects of embodiments of the present disclosure.

FIG. 10A, FIG. 10B, FIG. 10C, and FIG. 10D are diagrams showing example locations of the lower barrier, extraction zones, and shapes of the lower barrier as per aspects of embodiments of the present disclosure.

FIG. 11A, FIG. 11B, and FIG. 11C are diagrams showing example positions of upper barrier(s) as per aspects of embodiments of the present disclosure.

FIG. 12 is an example flow diagram of an aspect of an embodiment of the present disclosure.

FIG. 13 is an example flow diagram of an aspect of an embodiment of the present disclosure.

FIG. 14 is an example flow diagram of an aspect of an embodiment of the present disclosure.

### DETAILED DESCRIPTION OF EMBODIMENTS

The following detailed description refers to the accompanying drawings. The same reference numbers in different drawings may identify the same or similar elements. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that additional embodiments may comprise combinations of disclosed and equivalent embodiments.

Embodiments relate to controlling liquid flow. barriers may control the flow of liquid through a cartridge while creating mixtures of the liquid with various substances within the cartridge. As the liquid passes through the cartridge, barriers form internal compartments that may comprise substances that may diffuse into the liquid, while the barriers control the flow of the liquid through the cartridge. This control includes, but is not limited to, retarding the flow of the liquid, widening the stream of the liquid, creating multiple streams of the liquid, reducing the amount of liquid flowing through the cartridge, combinations of, and/or the like.

Embodiments of the present invention relate generally to the provision of a novel solution mixing cartridge. One of the various uses of a solution mixing cartridge is as a single serve beverage cartridge configured to produce beverages such as tea, coffee and/or the like. However, one skilled in the art will recognize that this novel cartridge configuration may be employed in other areas wherein a cartridge may be employed to create a solution by mixing a substance and a solute, for example, a cartridge for mixing glue, paint, and/or the like.

A solution may be a mixture that includes a solute substance dissolved (or partially dissolved) in a solvent substance. The solvent may do the dissolving. The solution may, more or less, take on the characteristics of the solvent including its phase, and the solvent may be the major fraction of the mixture. The concentration of a solute in a solution may be a measure of how much of that solute is dissolved in the solvent.

A solute may be a chemically different liquid, solid or gas than a solvent. A solvent is usually a liquid but can also be a solid or a gas. The maximum quantity of solute that can dissolve in a specific volume of solvent varies with temperature. Common uses for organic solvents are in dry cleaning (e.g., tetrachloroethylene), as paint thinners (e.g., toluene, turpentine), as nail polish removers and glue solvents (acetone, methyl acetate, ethyl acetate), in spot removers (e.g., hexane, petrol ether), in detergents (citrus terpenes), in perfumes (ethanol), nail polish and in chemical synthesis. The use of inorganic solvents (other than water) may be employed in research chemistry and some technological processes.

An example of one of various solutions that may be produced using solution mixing cartridge embodiments may be a beverage. A beverage may include a drink or other liquid prepared for human consumption. Examples of beverages include, but are not limited to: juice, soft drinks, carbonated drinks, coffee, teas, combinations thereof, and/or the like. Tea is an aromatic beverage commonly prepared by pouring hot or boiling water over leaves of the tea plant at which time the hot water may act as a solvent to dissolve parts of the tea leaves (acting as a solute) to form a tea solution. Some beverages may include alcohol.

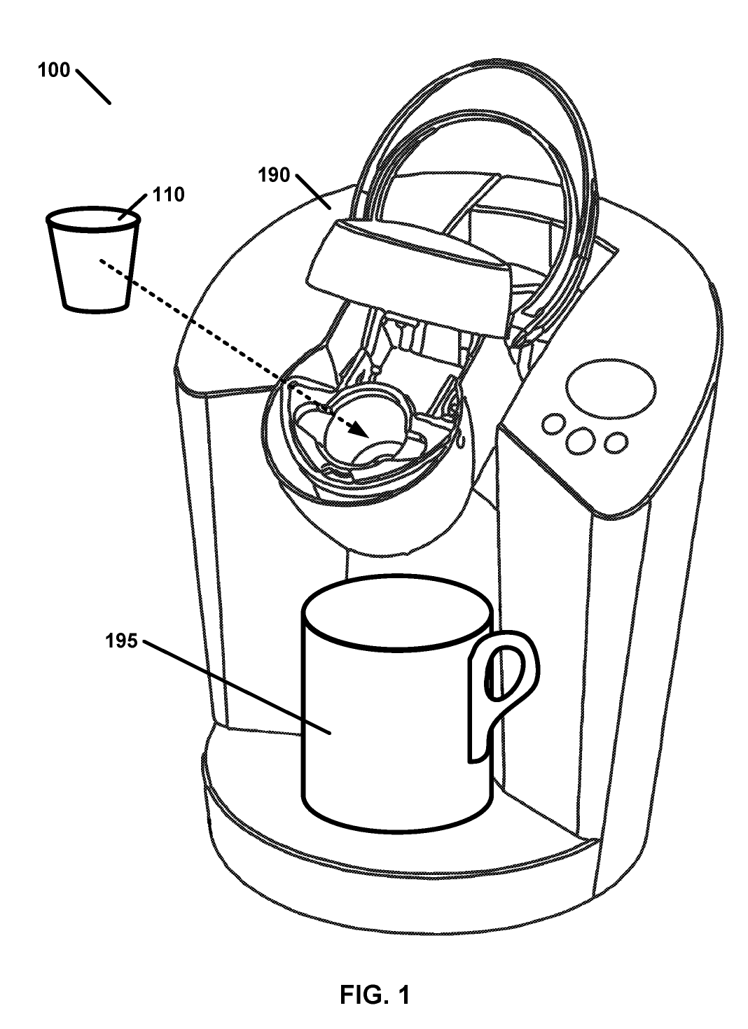

FIG. 1 which is a diagram illustrating a system 100 that may employ a beverage machine 190 and cartridge 110 to produce a beverage solution. The beverage cartridge 110 may be used in a beverage machine 190 to form a suitable beverage such as tea, coffee, other infusion-type beverages, beverages formed from a liquid or powdered concentrate, etc. In this illustrative embodiment, the cartridge 110 may be configured for use with a beverage machine 190 to form a beverage such as coffee, tea, and/or the like. However, as discussed earlier, aspects of the cartridge 110 are not limited in this respect.

In this illustrative example, system 100 may direct the flow of a liquid through an injection system 190, into cartridge 110, and collect the product in Reservoir 195. For example, system 100 may pump water from a storage reservoir, heat the water, and employ injection system 190 to inject heated water into cartridge 110. Injection system 190 may inject the heated water into cartridge 110 employing needle(s) configured to puncture cartridge 110 in its lid or sides. System 100 may also pierce a lower portion of cartridge 110 with needle(s) configured to puncture the base or sides to create a hole(s). The heated water may then flow through cartridge 110, interact with substances inside cartridge 110, exciting through the hole(s) created by the needle(s). The substances inside cartridge 110 may comprise beverage constituents, such as, but is not limited to, creamed honey and tea leaves.

According to some of the various embodiments, cartridge 110 may be placed in brewing machine 190 and operated to generate, for example, a hot beverage. Cartridge 110 may comprise, a container, a filter, a brewing medium and a lid. The brewing medium may include a brewing material such as coffee, tea, hot chocolate, and/or the like. The brewing machine 190 may puncture the lid and the bottom of the cartridge and force hot water under pressure through the cartridge and into a mug 195.

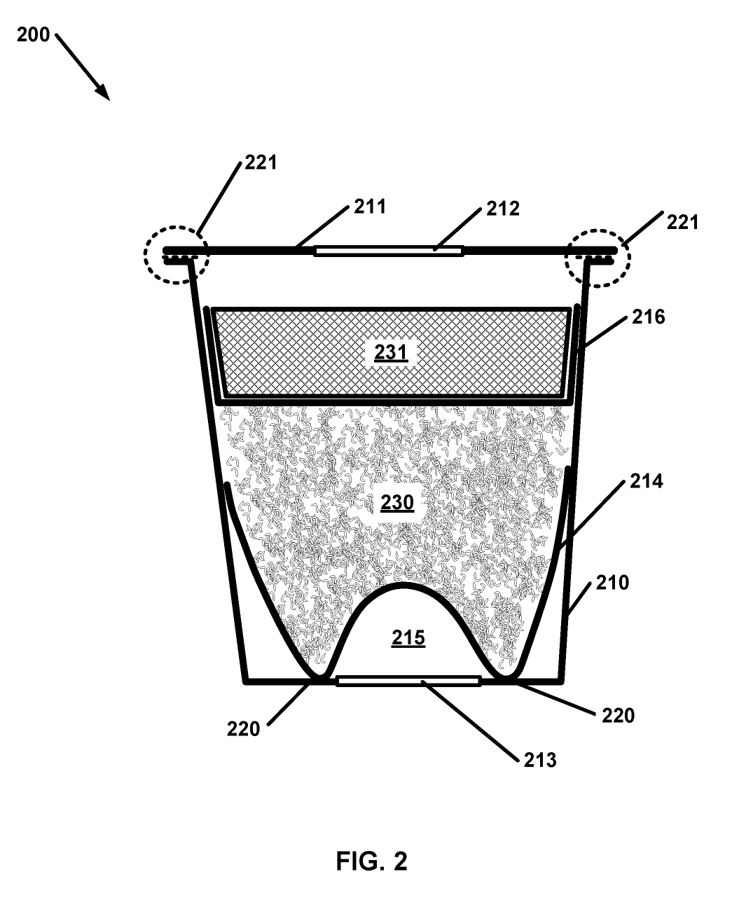

FIG. 2 is a diagram of a cross-section of an example of cartridge 200. Cartridge 200 may comprise cup 210 and lid 211. Cup 210 may comprise a material suitable to contain a liquid and/or mixture within the cartridge 200, such as, but is not limited to, metal, ceramic, glass, plastics, food grade polyethylene, plant fiber, graphene, combinations thereof, and/or the like. Lid 211 may comprise a material suitable to hold back a liquid, such as metal, ceramic, glass, plastic, food grade polyethylene, plant fiber, graphene, a combination thereof and/or the like. Cup 210 may comprise lip 221. Lip 221 may be where lid 211 may be sealed onto cup 210. Sealing may include, but is not limited to, gluing, welding, heat sealing, a combination thereof, and/or the like. Lid 211 may comprise injection zone 212, in which system 100 may inject a liquid into cartridge 200. Cup 210 may have an evacuation zone 213, where the resulting product may leave cartridge 200. Both the injection zone 212 and/or evacuation zone 213 may be configured to be punctured by a needle. Injection zone 212 and/or evacuation zone 210 may comprise a material that may be punctured, such as, but is not limited to, polypropylene, polyethylene, aluminum, rubber, plant fiber, graphene, or a combination thereof, and/or the like. Injection zone 212 and/or evacuation zone 213 may be connected to a coupler, such as, but is not limited to, tubing, threaded connectors, snap connectors, leur locks, a combination thereof, and/or the like. Injection zone 212 and/or evacuation zone 210 may comprise a material that is structurally configured to reseal after, for example, a needle is removed. The structural resealing configuration may comprise a flexible material such as rubber, a valve construction, combinations thereof, and/or the like. Evacuation chamber 215 may be bound by a portion of cup 210 and a portion of lower barrier 214. Evacuation chamber 215 may be above evacuation zone 213. Evacuation chamber 222 may be bound, at least on part, by a shaped portion of lower barrier 214. The shaped portion may be in the shape of a dome, a pyramid, a cube, a combination thereof, and/or the like. The shaped portion may be preshaped. Lower barrier 214 may comprise of a malleable, liquid permeable substance, such as, but is not limited to, a coffee filter, metal mesh, a ceramic filter, plant fiber, graphene, a combination thereof, and/or the like. Lower barrier 214 may be sealed to cup 210 at sealing points 220, and may be sealed by, but not limited to, gluing, welding, heat sealing, a combination thereof, and/or the like. Additionally, lower barrier 214 may have a portion communicating with cup 210 along cup 210's sidewall. Lower substance 230 may be substantially bound by lower barrier 214, the sidewalls of lower barrier 214 and/or the sidewalls of cup 210, and upper barrier 231. Lower substance 230 may be a substance that may at least partially diffuse into an injected liquid, such as, but is not limited to, tea leaves, powdered milk, flavored electrolyte mix, coffee, an epoxy constituent, a combination of, and/or the like. Upper barrier 216 may be placed substantially above lower substance 230. Upper barrier 216 may comprise of a liquid permeable substance, such as, but is not limited to, a coffee filter, metal mesh, a ceramic filter, plant fiber, graphene, a combination thereof, and/or the like. Upper barrier 216 may comprise of a liquid proof material, such as, but is not limited to, parchment paper, metal foil, a ceramic sheet, plant fiber, graphene, a combination thereof, and/or the like. Upper substance 231 may be substantially bound by the base of upper barrier 216, the sidewalls of upper barrier 216 and/or the sidewalls of cup 210, and lid 211. Upper substance 231 may comprise a material that may at least partially diffuse into an injected liquid, such as, but is not limited to, creamed honey, crystalized sugar, an epoxy constituent, syrup, a combination thereof, and/or the like.

Upper substance 231 and/or lower substance 230 may comprise a beverage medium, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriceuticals, etc.), and/or other beverage-making material (such as powdered milk or other creamers, creamed honey, honey sweeteners, thickeners, flavorings, and so on). One skilled in the art will recognize that other substances may be employed to generate various and/or alternative embodiments. Examples of other upper substance 231 and/or lower substance 230 may comprise, for example, glue, cleaning solutions, and/or the like.

Upper substance 231 and/or lower substance 230, may comprise, at least part, a brewable ingredient. Upper substance 231 and/or lower substance 230, may comprise, at least part, an infusible ingredient. Additionally, upper substance 231 and/or lower substance 230 may comprise, at least part, a sweetener such as, but not limited to, creamed honey, sugar, artificial sweeteners, stevia, aspartame, sucralose, neotame, acesulfame potassium, saccharin, combinations thereof, and/or the like.

Upper substance 231 and/or lower substance 230 may comprise creamed honey. Creamed honey is a honey that has been processed to control crystallization. Creamed honey may contain a large number of small crystals, which prevent the formation of larger crystals that can occur in unprocessed honey. The processing may also produce a honey with a smooth spreadable consistency. Other names for creamed honey include whipped honey, spun honey, churned honey, candied honey, honey fondant, and (in the UK) set honey. In other words, creamed honey may be formed when micro crystals form and spread in the honey due, in part, because of the large sugar content in honey. One process for initiating the process of creating creamed honey may include introducing seed crystal(s) into the honey. The honey may then be cooled, for example, through refrigeration. As the honey crystalizes, the viscosity of the honey may increase and the clarity of the honey may decrease. Pre-creamed honey may, for example, be made of 90-95% regular honey and 5-10% creamed honey.

According to the various embodiments, upper substance 231 and/or lower substance 230 may be presweetened with creamed honey by many processes beyond what has been described above, including, but not limited to: mixing the substance with the creamed honey, blending the substance with the creamed honey, coating the substance with the creamed honey, chemically bonding the creamed honey to the substance. For example, when a substance is tea, the tea may be coated with a layer of creamed honey prior to being placed in the cartridge. Expanding on the tea example, the tea may be mixed or blended with creamed honey prior to being placed in the cartridge. The blending and/or mixing may employ a mechanical device such as a blender. The substance and the honey may be pre-processed together prior to being placed in the cartridge. Preprocessing may include heating the substance (e.g. tea, coffee, etc) along with honey, and potentially a liquid. Crystals may then be introduced into the resultant mixture and cooled to let the sugar content of the honey crystalize.

In accordance with an aspect of the invention, lower barrier 214 may be attached to cup 210 on at least one or more portions, as indicated as a point of attachment 220. lower barrier 214 may comprise a shaped portion. The shaped portion may have a concave middle area configured to surround at least a portion of extraction zone 213 forming evacuation chamber 215.

Lower barrier 214 and/or upper barrier 216 may comprise filter paper arranged to allow a liquid and dissolved and/or suspended materials of a certain size to pass, yet prevent relatively large particles from flowing through. According to some of the various embodiments, lower barrier 214 and/or upper barrier 216 may have multiple stages, e.g., a coarse filter portion that filters out relatively large particles, followed by a fine filter portion that filters relatively smaller particles, and so on. In addition, lower barrier 214 and/or upper barrier 216 may include one or more portions that function to filter liquid passing through, as well as portions that may be impermeable or otherwise restrict flow. Thus, lower barrier 214 and/or upper barrier 216 may include two or more separate components, if desired. Furthermore, not all portions of lower barrier 214 and/or upper barrier 216 may need to be permeable to liquids. Lower barrier 214 and/or upper barrier 216 may also have areas with different permeability, e.g., to help direct flow toward one or more areas. For example, regions lower barrier 214 and/or upper barrier 216 may have a relatively lower permeability as compared to regions to encourage flow through cup 210 towards lower regions of cup 210.

Lower barrier 214 and/or upper barrier 216 may also, or alternately, function to help prevent the movement of materials between chambers formed, at least in part, by the barriers. Lower barrier 214 may help prevent contact of the upper substance and/or lower substance with a needle that pierces the extraction zone 213. For example, some beverage media such as honey or powdered drink mixes may clog or otherwise foul an inlet needle if allowed to contact the needle. Lower barrier 214 and/or upper barrier 216 may help prevent such contact, helping to maintain proper operation of the cartridge and preparation of a beverage.

Lower barrier 214 and/or upper barrier 216 may each have a shape such as a fluted or conical shape with pleated sidewalls and a concave middle area. Lower barrier 214 and/or upper barrier 216 may be attached to cup 210 in many ways, such as by an adhesive, thermal welding, ultrasonic welding, chemical bonding, crimping, other mechanical bonding, a combination thereof, and/or the like. For example, the lower barrier 214 may be attached to a periphery of a shaped zone to container 210 by gluing or heat sealing. Lower barrier 214 and/or upper barrier 216 may include a permeable filter paper made of a combination of polypropylene and cellulose materials and may be attached to the bottom portion of the container 290 by thermal welding.

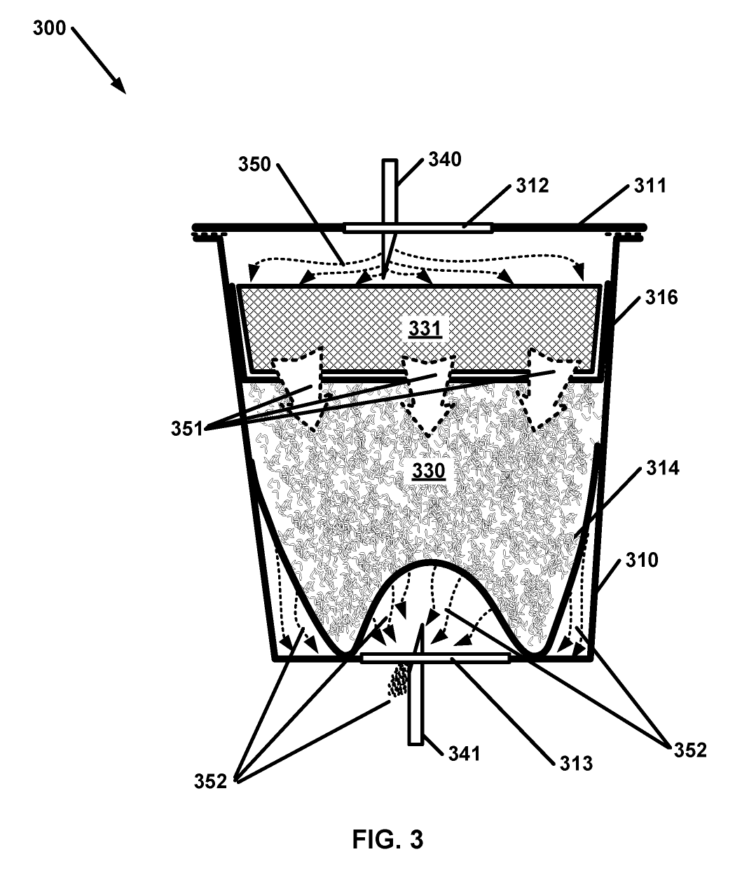

FIG. 3 is an illustration showing an example cartridge 300 controlling a flow of liquid. Liquid may be introduced in a stream into cartridge 300 via injection needle 340 through injection zone 312 of lid 311. Lid 311 may be sealed to cup 310. Liquid stream 350 may enter cup 310 though lid 311 and may encounter upper substance 331. Upper barrier 316 may comprise one or more sidewalls which may abut the sidewall of cup 310. This may prevent a mixture, which may be made from the injected liquid and upper substance 331, from flowing over the sidewall of upper barrier 316. Upper mixture 351 may be controlled by upper barrier 316 through openings, pores, and/or the like in upper barrier 316, down into a lower chamber. Holes and/or pores in upper barrier 316 may direct upper mixture 351 to spread the upper mixture 351 over a lower area. Upper mixture 351 may interact with lower substance 330, creating lower mixture 352. Lower mixture 352 may flow through lower barrier 314 into extraction chamber 315. Lower mixture 352 may be extracted through evacuation needle 341. Evacuation needle 341 may pierce cup 310 in evacuation zone 313.

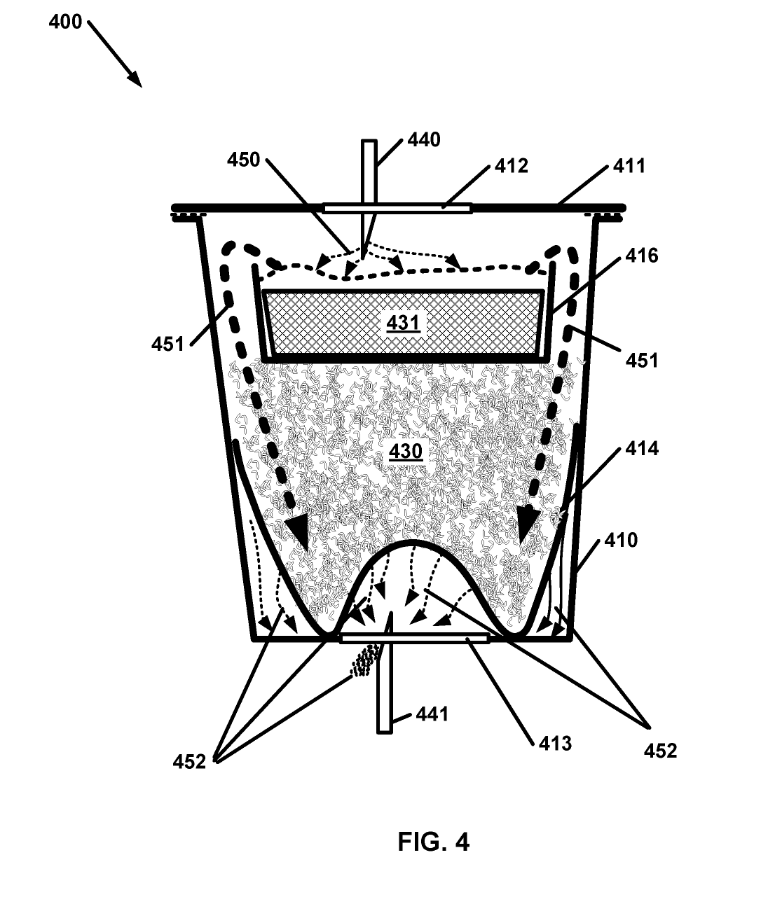

FIG. 4 illustrates of an example cartridge 400 controlling liquid flow. In this embodiment, upper barrier 416 may have sidewalls, but may not fully seal off the upper chamber because it may not have sidewalls substantially abutting or sealed against the sidewalls of cup 410. Liquid 450 may be introduced into the cartridge through injection needle 440, piercing injection zone 412 of lid 411. Liquid 450 may encounter an upper substance 431, creating Upper injection needle 451. Upper barrier 416 may widen at least a portion of Upper injection needle 451 by directing Upper injection needle 451 over the sides of upper barrier 416 into a lower chamber, bounded, at least in part, by lower barrier 414. Upper mixture 451 may encounter lower substance 430. Upper mixture 451 may interact with lower substance 430, creating lower mixture 452. At least a portion of lower mixture 452 may pass through lower barrier 414 and may be extracted through evacuation needle 441, piercing through evacuation zone 413 of cup 410.

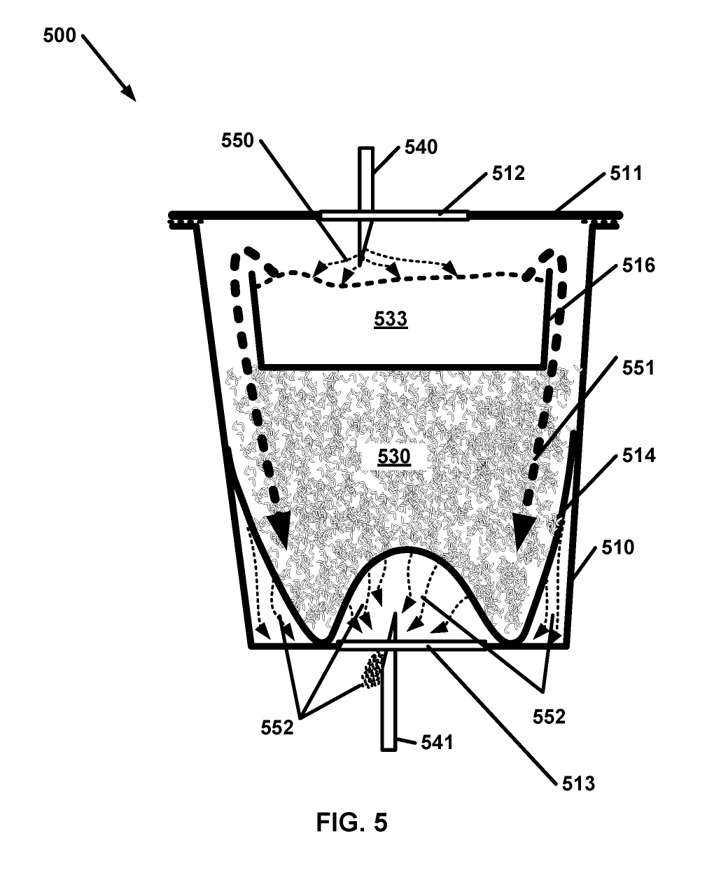

FIG. 5 illustrates an example cartridge 500. In this embodiment, liquid 550 may be introduced into cartridge 500 through injection needle 540, piercing through injection zone 512, of lid 511. Liquid 550 may pool in open chamber 533. Open chamber 533 may collect liquid 550 until enough of liquid 550 has been collected to run over the sides of upper barrier 516. Upper barrier 516 may direct liquid 550 to run over the sides of upper barrier 516, as upper liquid 551. Upper liquid 551 flow may be widened, covering an area of a lower chamber holding lower substance 530. Upper liquid 551 may interact with lower substance 530 forming lower mixture 552. Lower mixture 552 may flow from the lower chamber to evacuation needle 541. Evacuation needle 541 may enter cup 510 by piercing evacuation zone 513 of cup 510.

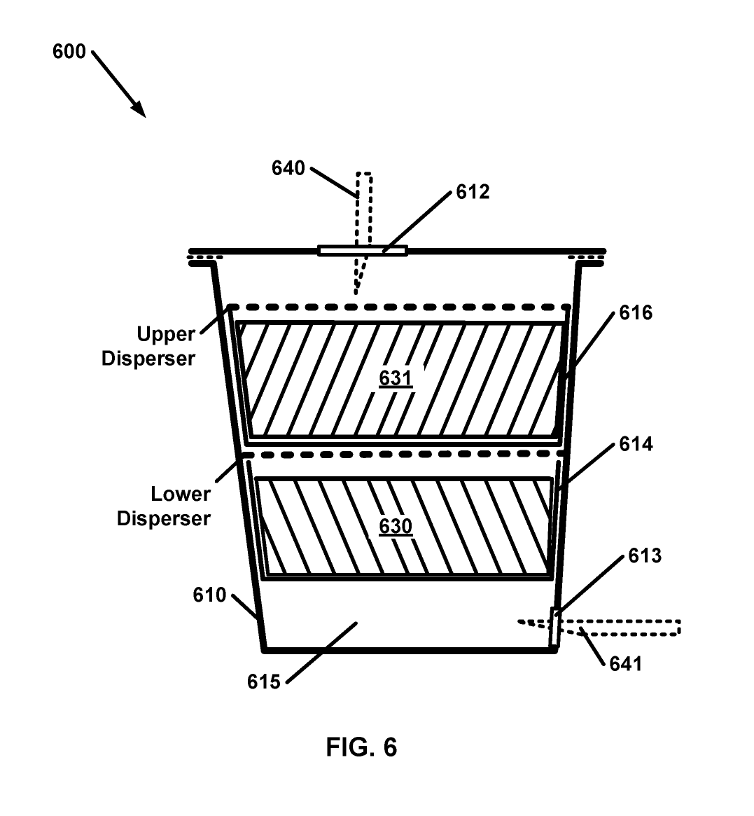

FIG. 6 illustrates an embodiment of example cartridge 600. Injection needle 640 may enter cartridge 600 through injection zone 612. Upper barrier 616 may comprise an upper substance 631 and lower barrier 614 may comprise a lower substance 630. Lower barrier 614 may, for example, comprise a substantially flat bottom. Evacuation chamber 615 may be bounded, at least in part, by a lower portion of cup 610. Per an embodiment, and as illustrated in this example, evacuation zone 613 may be disposed in the sidewall of the cup 610 and evacuation needle 641 may pierce through the sidewall of cup 610.

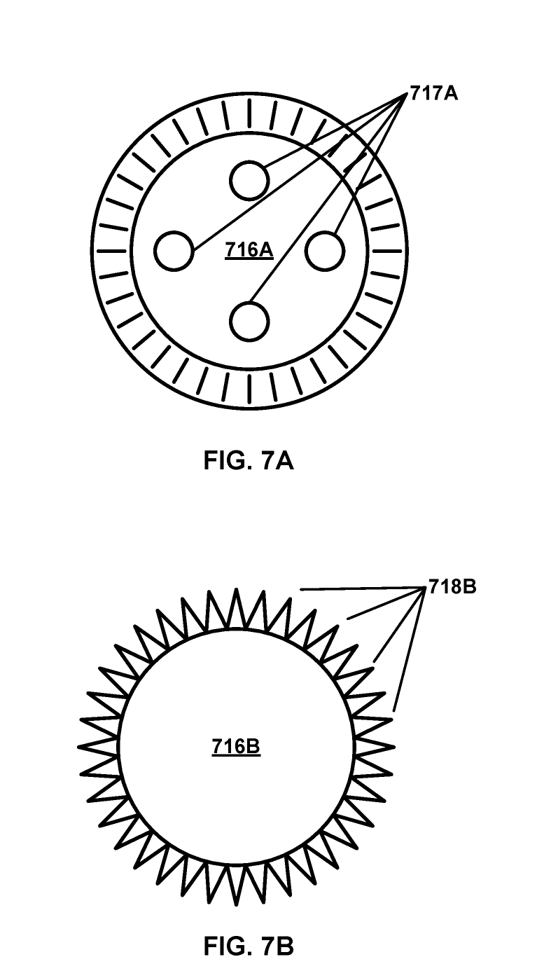

FIG. 7A and FIG. 7B show example embodiment configurations of the upper barrier 716A and upper barrier 716B. FIG. 7A illustrates a possible arrangement of openings 717A in upper barrier 716A to allow liquid to pass out the bottom of the upper barrier 716A. FIG. 7B illustrates a Pleated Edge 718B on upper barrier 716B to allow liquid to pass between the upper barrier 716B and the wall of a cup in a controlled flow.

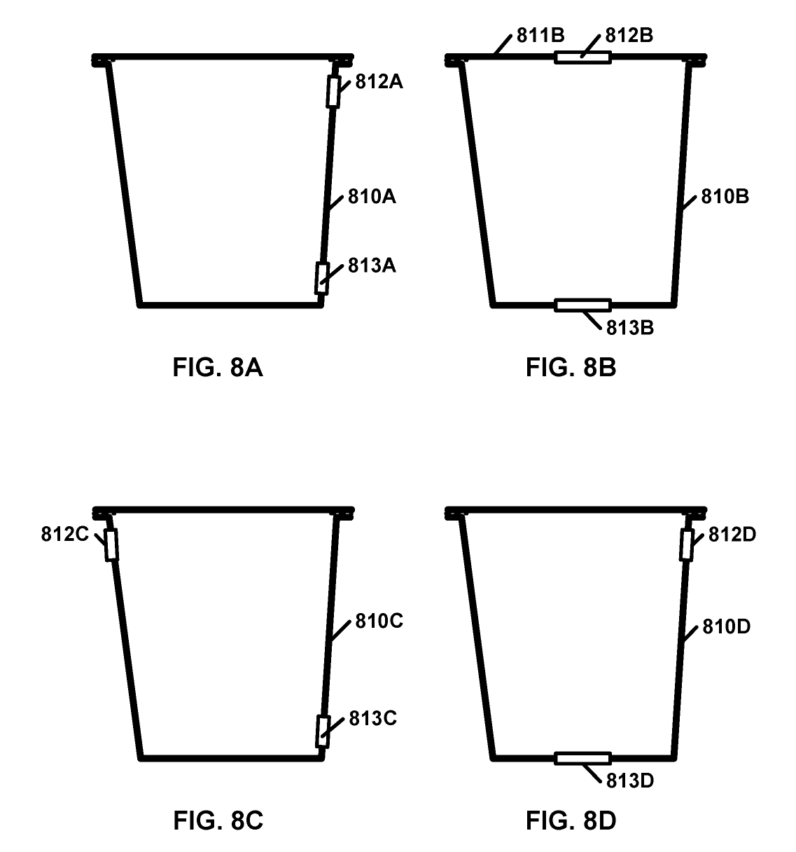

FIG. 8A, FIG. 8B, FIG. 8C, and FIG. 8D show embodiments with example configurations of injection zone(s) and evacuation zone(s). FIG. 8A illustrates an example embodiment where injection zone 812A and evacuation zone 813A may be placed on the same side of cup 810A. FIG. 8B illustrates an embodiment where injection zone 812B may be in lid 811B and evacuation zone 813B in the base of cup 810B. FIG. 8C illustrates an embodiment with injection zone 812C on an opposing side to evacuation zone 813C on the sidewalls of cup 810C. FIG. 8D illustrates an embodiment where injection zone 812D may be in the sidewall of cup 810D and evacuation zone 813D may be in the base of cup 810D.

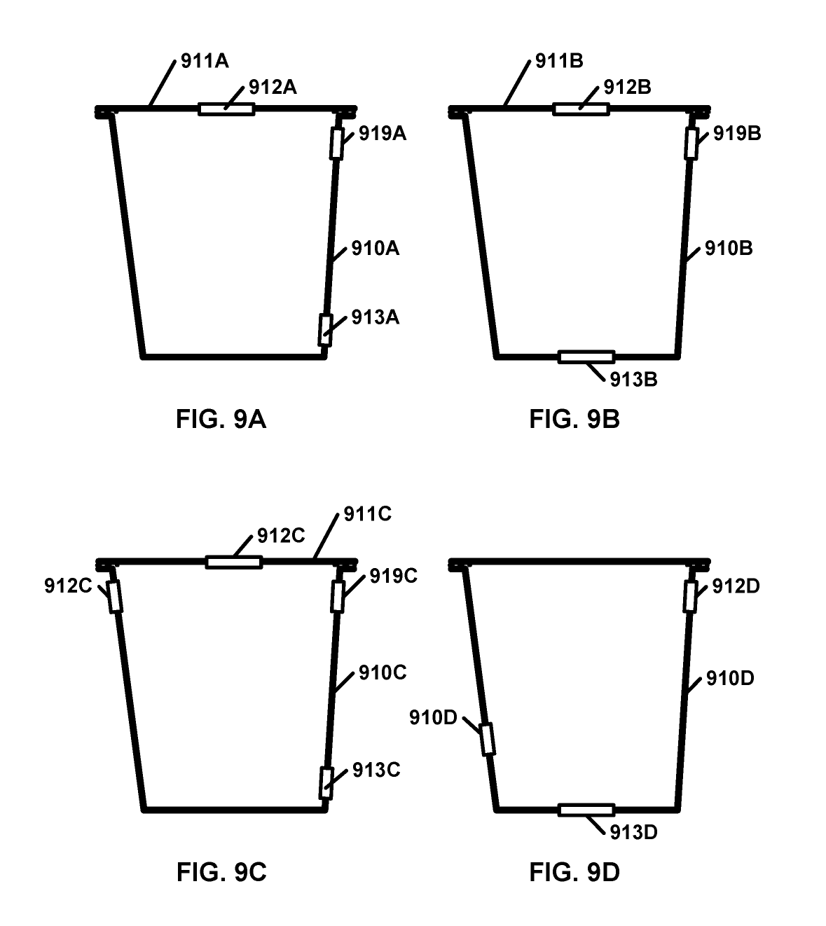

FIG. 9A, FIG. 9B, FIG. 9C, and FIG. 9D illustrates example embodiments of possible multiple injection zone configurations. FIG. 9A illustrates an embodiment where a first injection zone 912A may be in lid 911A and a second injection zone 919A may be in the sidewall of cup 910A. Evacuation zone 913A may be positioned in the sidewall of cup 910A on the same side as injection zone 919A. FIG. 9B illustrates an embodiment where a first injection zone 912B may be in lid 911B and a second injection zone 919B may be in the sidewall of cup 910B. Evacuation zone 913B may be in the base of the cup 910B. FIG. 9C illustrates an embodiment where a first injection zone 912C may be in lid 911C and a second injection zone 919C may be in the sidewall of cup 910C on a different side as evacuation zone 913C. Evacuation zone 913C may be position on the sidewall of cup 910C. FIG. 9D illustrates an embodiment where a first injection zone 912D and a second injection zone 919D may both be in the sidewall of cup 910D. Evacuation zone 913D may be position in the base of the cup.

Other configurations are possible, such as, but is not limited to: having three or more injection zones in any configuration, having injection zones both on the sidewall of the cup, but not in the same plane as shown in FIG. 9D, having multiple injection zones and the evacuation zone all in the sidewall of the cup, having multiple injection zones in the lid, having multiple injection zones in both the lid and the sidewall of the cup, a combination thereof, and/or the like. The cup and lid may also be made of a material that would allow portion(s) of the cup to be punctured by a needle. According to some embodiments, different injection zones may be employed in the injection of different liquids. The different liquids may be mixed inside the cartridge. The different liquids may be injected at different injection rates. Combinations of interior barriers and injection rates may provide for customized mixtures. Different mixture combinations may be extracted through different evacuation zones.

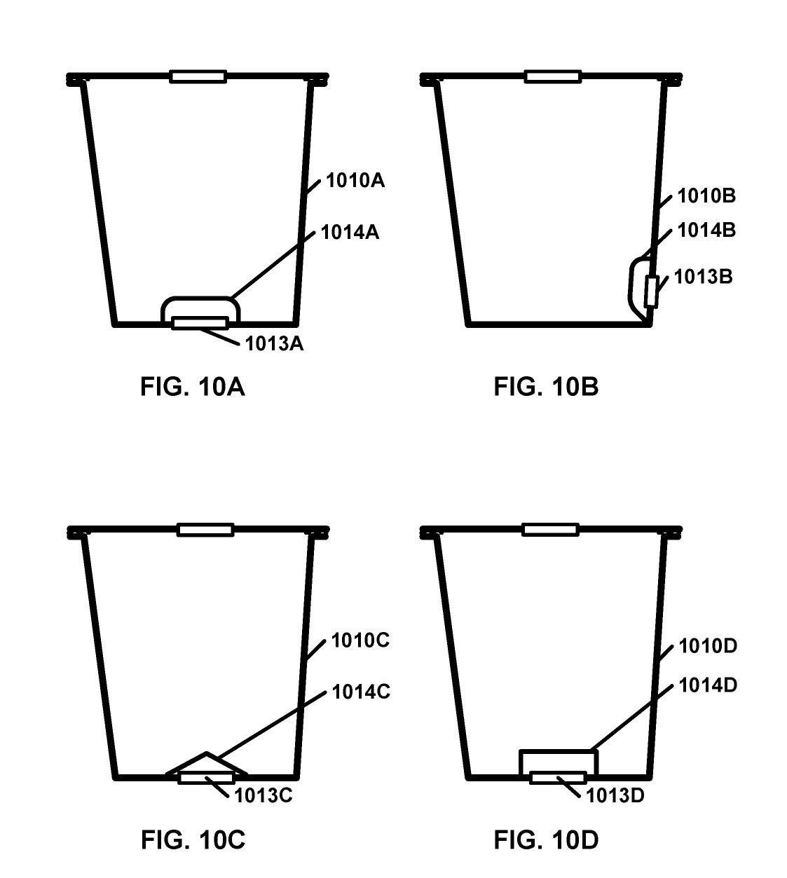

FIG. 10A, FIG. 10B, FIG. 10C, and FIG. 10D illustrate example embodiments of the lower barrier. FIG. 10A shows an example embodiment of a dome shaped lower barrier 1014A, without the portion in communication with the sidewall of cup 1010A. Evacuation zone 1013A may be positioned in the base of cup 1010A and under lower barrier 1014A. FIG. 10B shows an example embodiment where evacuation zone 1013B may be position in the sidewall of cup 1010A, and where a dome shamed lower barrier 1014B may surround evacuation zone 1013B. Lower barrier 1014B may be attached either to the sidewall or to the sidewall and base of cup 1010B. FIG. 10C shows an embodiment where lower barrier 1014C may be pyramidal and may be located around evacuation zone 1013C. Evacuation zone 1013C may be in the base of cup 1010C, but may also be in the sidewall of cup 1010C as illustrated in other embodiments. FIG. 10D shows an embodiment where lower barrier 1014D may be cubic or cylindrical and may be located around evacuation zone 1013C. Evacuation zone 1013D may be in the base of cup 1010D, but may also be in the sidewall of cup 1010C as illustrated in above embodiments.

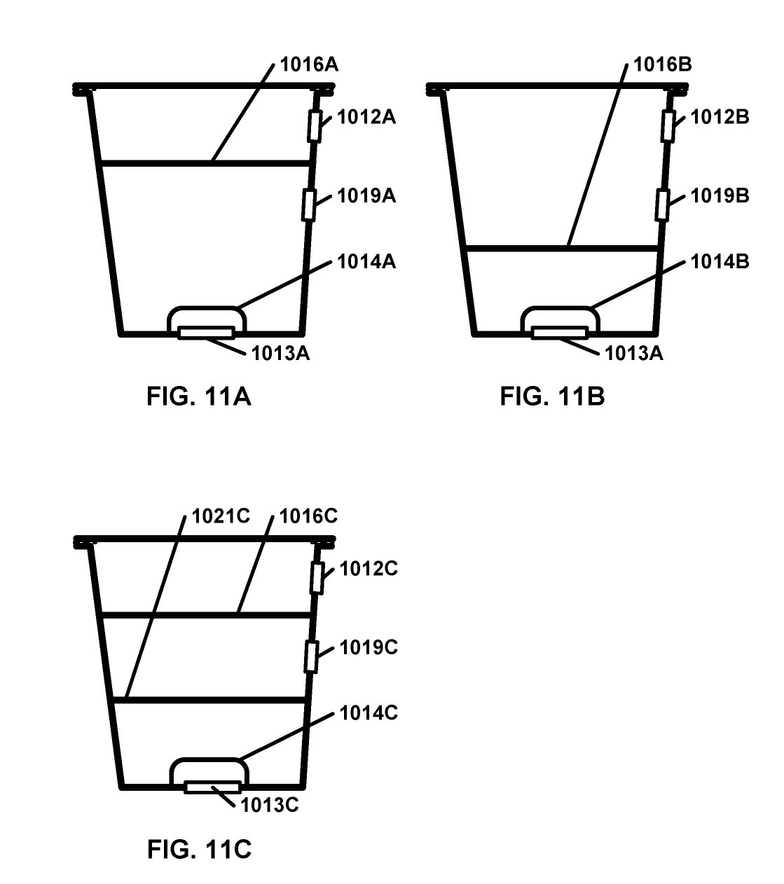

FIG. 11A, FIG. 11B, and FIG. 11C illustrate example configurations of the position of one or more upper barriers. FIG. 11A shows an embodiment where upper barrier 1116A may be between a first sidewall injection zones 1112A and a second sidewall injection zone 1119A, and above lower barrier 1114A. Lower barrier 1114A is illustrated over evacuation zone 1013A. FIG. 11B shows an embodiment where upper barrier 1116B may be below a first injection zone 1112B and a second injection zone 1119B, and above upper barrier 1116C. Lower barrier 1114B is illustrated over evacuation zone 1013B. FIG. 11C shows an embodiment where a first upper barrier 1116C may be below a first injection zone 1112C, a second upper barrier 1121C may be below a second injection zone 1119C. The second upper barrier 1121C is above lower barrier 1114C. Lower barrier 1114C is illustrated over evacuation zone 1013C.

Other configurations are also possible, such as, but is not limited to, three or more upper barriers, either separated by injection zones or all below at least one injection zone. Additionally, the evacuation zone does not need to be in the base of the cup as illustrated in FIG. 11A through FIG. 11C, but may have other configurations as illustrated in FIG. 9A, FIG. 9C, and FIG. 10B in combination with multiple upper barriers.

The cartridge lid may be of various materials. The lid material may be selected based on the type of liquid, substances, and/or operating conditions (e.g. pressure, temperature, etc.) of the cartridge. This may include, but is not limited to, metal, ceramic, glass, plastics, food-grade polyethylene, plant fiber, graphene, a combination thereof, and/or the like. The lid may either be sealed onto the cup or may be configured to be removable. Further, the lid may be configured to be reusable. If the lid is sealed, the sealing may be done by gluing, welding, heat sealed, a combination thereof, and/or the like. Sealing may be performed to a lip of the cup or directly to the cup. A lid may be made to be removable and reusable by means of, but not limited to, an O-ring, a gasket, by threading, a pressure cuff, a combination thereof, and/or the like. The lid may also be configured with an injection zone.

Per an embodiment, a cartridge cup may be constructed of material chosen for compatibility with the type of liquid and substances within the cartridge. This may include, but not limited to, metal, ceramic, glass, plastics, food-grade polyethylene, plant fiber, graphene, a combination thereof, and/or the like. The interior of the cup may be configured with sections that may accept internal sealing, such as, but is not limited to a gasket or O-ring to allow the upper or lower barriers to be removed and replaced.

Per an embodiment, a cartridge may have one or more upper barriers. The upper barrier may be either permeable to a liquid or mixture or impermeable. If permeable, the barrier may be made of a metal mesh, cheesecloth, Whatman paper, ceramic, silicon, coffee filter, plant fiber, graphene, a combination thereof, and/or the like. An impermeable upper filter may be made of a metal, ceramic, stone, glass, baking paper, plant fiber, graphene, a combination thereof, and/or the like. The upper barrier may have a sidewall. The sidewall may be pleated to create multiple streams of liquid and to allow a liquid to pass below the upper barrier. The upper barrier may have openings cut into the bottom of the upper barrier to create multiple flows of liquid and to allow the passage of liquid through the upper barrier. The upper barrier may be sealed against the sidewall of the cup, rest on a lower substance, and/or be configured to be removable and replaceable. The upper barrier may be sealed against the sidewall using gluing, welding, heat sealing, a combination thereof, and/or the like. An upper barrier may be configured with a with a gasket or an O-ring to be made removeable and replaceable within the cup. An upper barrier may create an upper compartment with either the lid or with another upper barrier. The upper compartment may comprise of an upper substance.

The lower barrier may be configured around an evacuation zone. The lower barrier may be made of a mixture permeable substance, such as, but is not limited to, metal, ceramic, Whatman paper, cheesecloth, plastic, silicon, a coffee filter, plant fiber, graphene, a combination thereof, and/or the like. The lower barrier may have a shaped bottom, which may be shaped by negative or positive pressure, or injection molding. The lower barrier may be sealed to the bottom of the cup using, but not limited to, gluing, welding, heat sealing, a combination thereof, and/or the like. The lower barrier may be alternatively, or in addition to the sealing to the bottom, also be sealed against the sidewall of the cup through for example, but not limited to, gluing, welding, heat sealing, or a combination thereof, and/or the like. The lower barrier may be configured to be removable and/or replaceable by means of an O-ring or gasket or the like. The lower barrier may act as a lower boundary for a lower compartment with an upper barrier acting as an upper boundary. The lower barrier may act as an upper boundary for an evacuation compartment with the base or sidewall of the cup acting as the other boundaries, depending on if the evacuation zone is in the base or sidewall, respectively.

Per an embodiment, a cartridge may have at least one injection zone to introduce a liquid into its interior and one evacuation zone to remove the mixture. The injection and evacuation zones may be of the same substance as either the lid or sidewall of the cup. Alternatively, the injection zone and/or evacuation zone may be made of another substance, such as, but is not limited to, silicone, rubber, or plastic, a combination thereof, and/or the like. The injection and evacuation zones may be further configured to be resalable after use. Per an embodiment, the injection and evacuation zones may comprise an opening configured with an area to attach, for example, tubing. Liquid may be introduced through the injection zone by means of puncturing the injection zone with a needle or attaching tubing by means of, but not limited to, a gasket, O-ring, pressure cuff, a combination thereof, and/or the like. The mixture may be extracted through the evacuation zone by mean of, but not limited to, puncturing with a needle or attaching tubing by means of, but not limited to, a gasket, O-ring, pressure cuff, a combination thereof, and/or the like.

Liquid introduced into the cartridge through the injection zone may comprise of at least one of, but not limited to, hydrocarbons, oil, one component of an epoxy, saline, an acid, or base, water, a combination thereof, and/or the like. The liquid may be pure, a solution, or have other changes made, for example, carbonation, prior to injection.

Per an embodiment, a cartridge may have at least one upper substance in at least one of the upper compartments, and a lower substance in a lower compartment. Per an embodiment, the substance(s) may comprise, but not be limited to, crystalized sugar, salt, cocoa powder, flavored powder, such as, but is not limited to, lemonade powder, or electrolyte mix, or flavored syrup, ground coffee, corn syrup, agave nectar, an acid, a base, an epoxy component, powdered milk, creamed honey, a combination thereof, and/or the like.

The introduction and evacuation of the liquid may be through a system. The system may be connected to the cartridge, a liquid source, and a reservoir to collect the resulting mixture. The system control may be configured to use pressure to push the liquid through the cartridge in either a continuous pressure system, or may introduce the liquid and let it flow through the cartridge before applying suction to remove the liquid.

Per an embodiment of cartridge, the lid may be made of food-grade polypropylene and is heat sealed to a lip of the cup. The injection zone may be in the lid and may be made of food-grade polypropylene and may be configured to be punctured by an injection needle. The injection needle may introduce heated water into the cartridge. The heated water may encounter an upper substance. The upper substance may comprise creamed honey, creating an upper mixture of heated water and honey. The upper barrier may comprise baking paper and may have pleated sidewalls. The sidewalls may be partially abutting the sidewalls of the cup. The mixture may collect in the upper barrier until it runs over the upper barrier sidewalls and between the pleats down to below the upper barrier to a lower chamber. A lower substance may be in the lower chamber. The lower substance may be tea leaves. The upper substance may interact with the lower substance, making a lower mixture of heated, honey sweetened tea. The lower mixture may pass through the lower barrier. An evacuation needle may puncture the base of the cup in the evacuation zone to create a hole. The lower mixture may exit the cartridge through the evacuation zone.

An apparatus may comprise: a cup, a lid, an injection zone, an evacuation zone, an upper barrier, a lower barrier. According to an embodiment, the apparatus may further comprise a lower substance, and/or an upper substance.

The cup may comprise: a base and a sidewall rising from the base. The lid may be attached to a top of the sidewall. According to an embodiment, the lid may be structurally configured to be removeable.

The injection zone may be structurally configured to be pierceable by an injection needle. The injection zone may be disposed in at least one of the sidewall and the lid. According to an embodiment, the injection zone may be disposed between the lower barrier and the upper barrier. According to an embodiment, the apparatus may further comprise an additional injection zone disposed in at least one of the sidewall and the lid. According to an embodiment, at least one of the injection zone and an additional injection zone may be structurally configured to reseal after use.

The evacuation zone may be structurally configured to be pierceable by an evacuation needle. The evacuation zone may be disposed in at least one of the sidewall and the base. According to an embodiment, the apparatus may further comprise an additional evacuation zone disposed in at least one of the sidewall and the base. According to an embodiment, at least one of the evacuation zone and an additional evacuation zone may be structurally configured to reseal after use. According to an embodiment, the injection zone may be structurally configured to be pierced with a lower force than the extraction zone.

The lower barrier may comprise: a pre-shaped portion surrounding the evacuation zone. The lower barrier may comprise a periphery surrounding the pre-shaped portion. One or more attachment portions along the periphery may be fastened to the cup. According to an embodiment, the lower barrier may be liquid permeable. According to an embodiment, the lower barrier may be sealed to the sidewall. According to an embodiment, the pre-shaped portion may be concave.

The upper barrier may be positioned above the lower barrier and below the injection zone. According to an embodiment, at least one of the upper barrier and the lower barrier may be structurally configured to be removable. According to an embodiment, the upper barrier may comprise: an upper barrier base; and an upper barrier sidewall raising from the upper barrier base. According to an embodiment, the upper barrier may be impermeable to water. According to an embodiment, the upper barrier may comprise pores structurally configured to permit passage of liquid. According to an embodiment, the apparatus may further comprise at least one additional barrier positioned: above the lower barrier; and above the lower barrier.

The lower substance may be disposed above and in contact with the lower barrier. The upper substance may be disposed above and in contact with the upper barrier. According to an embodiment, an additional substance may be disposed above and in contact with additional barrier. According to an embodiment, at least one of the upper substance and the lower substance may comprise a dissolvable ingredient. According to an embodiment, at least one of the upper substance and the lower substance may comprise creamed honey. According to an embodiment, at least one of the upper substance and the lower substance may comprise at least one of: tea, ground coffee, lemonade powder, flavored electrolyte powder, sugar, or powdered milk. According to an embodiment, at least one of the upper substance and the lower substance may comprise at least one of: crystalized honey, flavored syrup concentrate, corn syrup, artificial sweetener, or agave nectar.

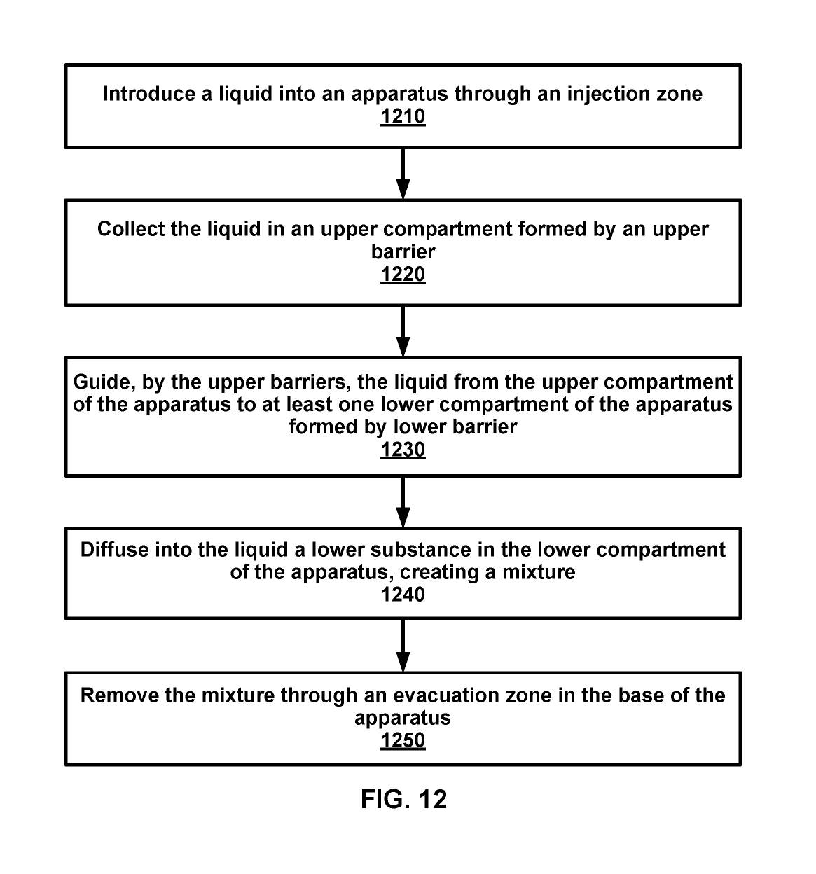

FIG. 12 is an example flow diagram as per an aspect of an embodiment of the present disclosure. The flow diagram illustrates an example operation of an apparatus as disclosed herein. At 1210, a liquid may be introduced into an apparatus through an injection zone. The liquid may be collected at 1220 in an upper compartment bounded, at least in part, by an upper barrier. At 1230, the liquid may be guided, by the upper barriers, from the upper compartment of the apparatus to at least one lower compartment of the apparatus. The lower compartment(s) may be bounded, at least in part, by lower barriers. At 1240, the liquid may be diffused into a lower substance in the lower compartment of the apparatus, creating a mixture. At 1250, the mixture may be removed through an evacuation zone. The evacuation zone may disposed in or proximate the base of the apparatus.

According to an embodiment, the liquid may comprise water. The liquid may be heated prior to being introduced into the apparatus. The liquid may be carbonated prior to being introduced into the apparatus. Pressure may be applied to direct the liquid through apparatus. According to an embodiment, an upper substance may be diffused in the upper compartment into an upper liquid. According to an embodiment, subsequent liquids may be introduced into the injection zone after the first liquid. Subsequent liquids may be introduced into a second injection zone. The subsequent liquids may be introduced concurrently with the first liquid. The subsequent liquids may be introduced sequentially. According to an embodiment, the lid of the apparatus may be punctured with an injection needle. The sidewall may be punctured with an injection needle above the uppermost barrier. The apparatus may be punctured with at least one additional injection needle. The liquid may be mixed with another substance prior to injection into the apparatus. The base of the apparatus may be punctured with an evacuation needle. The sidewall of the apparatus may be punctured with an evacuation needle below the lower barrier. The apparatus may be punctured with at least one additional evacuation needle.

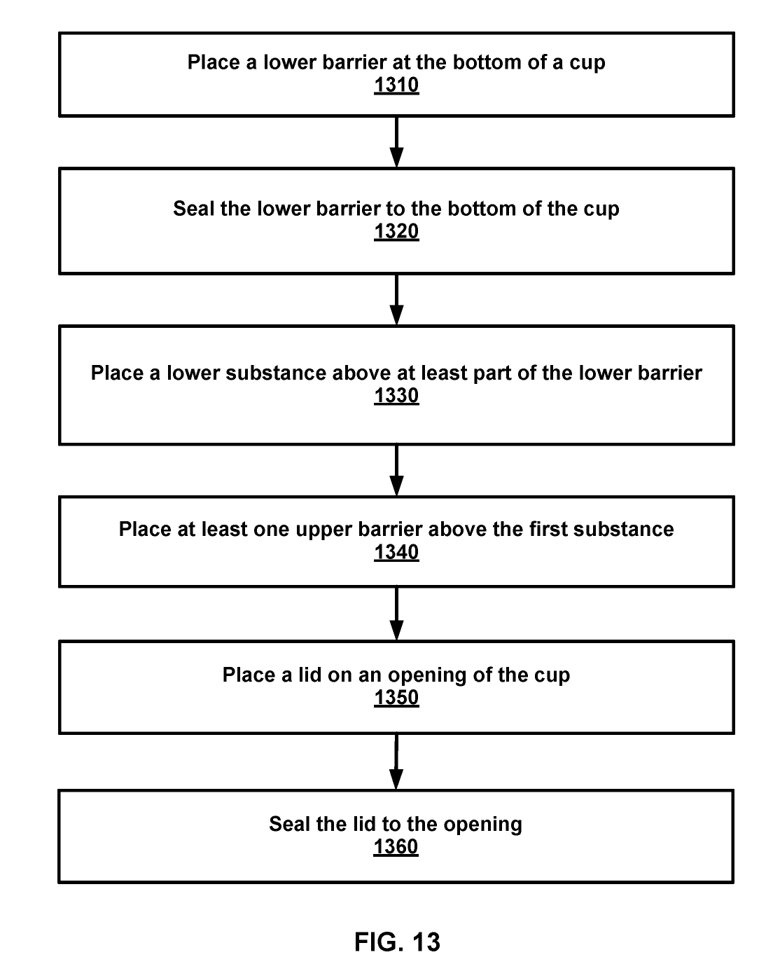

FIG. 13 is an example flow diagram as per an aspect of an embodiment of the present disclosure. The flow diagram illustrates an example manufacture of an apparatus as disclosed herein. At 1310, a lower barrier may be placed at the bottom of a cup. At 1320, the lower barrier may be sealed to the bottom of the cup. At 1330, a lower substance may be placed above at least part of the lower barrier. At 1340, at least one upper barrier may be placed above the first substance. At 1350, a lid may be placed on an opening of the cup. At 1360, the lid may be sealed to the opening.

According to an embodiment, at least one upper substance may be placed above at least one upper barrier. The sealing of the lid to the opening employs heat sealing. The sealing of the lid to the opening may further comprise at least one of: gluing or welding. The lower barrier may be sealed to the sidewall of the cup. The sealing of the lower barrier to the sidewall of the cup may further comprise at least one of: heat sealing, welding, or gluing. The lower barriers may be set into the sidewall. The sidewall may be configured to allow the lower barriers to be sealed via at least one of a gasket and O-ring. At least one of the upper barriers may be set into the sidewall. The sidewall may be configured to allow the upper barrier(s) to be sealed via at least one of a gasket and O-ring.

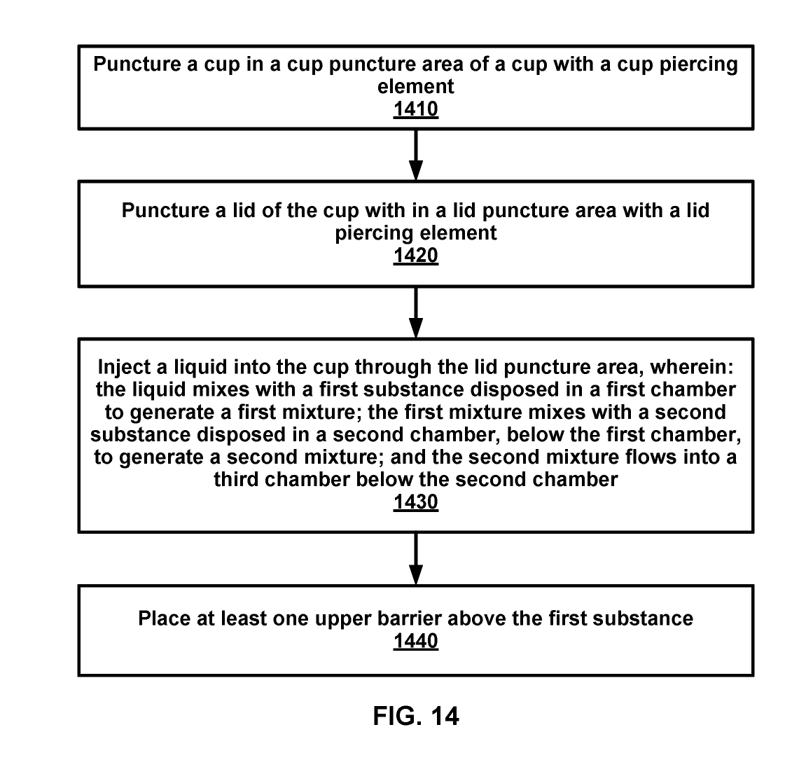

FIG. 14 is an example flow diagram as per an aspect of an embodiment of the present disclosure. At 1410, a cup may be punctured in a cup puncture zone with a cup piercing element. At 1420, a lid of the cup may be punctured in a lid puncture zone with a lid piercing element. At 1430, a liquid may be injected into the cup through the lid puncture area. The liquid may mix with a first substance disposed in a first chamber to generate a first mixture. The first mixture may mix with a second substance disposed in a second chamber, below the first chamber, to generate a second mixture. The second mixture may flow into a third chamber below the second chamber. At 1440, the second mixture may be extracted from the third chamber through the cup puncture zone.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, although the apparatus is described with respect to mixing beverages comprising substances such as tea and creamed honey, alternative embodiments may be employed to mix dyes, finishes, paint, adhesives, etc. Thus, the present embodiments should not be limited by any of the above described exemplary embodiments.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures. For example, the steps listed in any flowchart may be re-ordered or only optionally used in some embodiments.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed to one or more of the various embodiments. The phrase “based on” is indicative that the phrase following the term “based on” is an example of one of a multitude of suitable possibilities that may, or may not, be employed to one or more of the various embodiments. The phrase “in response to” is indicative that the phrase following the phrase “in response to” is an example of one of a multitude of suitable possibilities that may, or may not, be employed to one or more of the various embodiments. It should be noted the terms “including” and “comprising” should be interpreted as meaning “including, but not limited to”.

In this disclosure, various embodiments are disclosed. Limitations, features, and/or elements from the disclosed example embodiments may be combined to create further embodiments within the scope of the disclosure.

It is the applicant's intent that only claims that include the express language “means for” or “step for” be interpreted under 35 U.S.C. 112. Claims that do not expressly include the phrase “means for” or “step for” are not to be interpreted under 35 U.S.C. 112.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

1. An apparatus comprising:
a cup comprising:
a base; and
a sidewall rising from the base;
a lid attached to a top of the sidewall;
an injection zone, structurally configured to be pierceable by an injection needle, disposed in at least one of the sidewall and the lid;
an evacuation zone, structurally configured to be pierceable by an evacuation needle, disposed in at least one of the sidewall and the base;
a lower barrier comprising:
a pre-shaped portion surrounding the evacuation zone;
a periphery surrounding the pre-shaped portion; and
one or more attachment portions along the periphery fastened to the cup;
an upper barrier positioned:
above the lower barrier; and
below the injection zone;
a lower substance disposed above and in contact with the lower barrier; and
an upper substance disposed above and in contact with the upper barrier.

2. The apparatus of claim 1, further comprising at least one additional barrier positioned:
above the lower barrier; and
above the lower barrier.

3. The apparatus of claim 1, wherein at least one of the upper barrier and the lower barrier is structurally configured to be removable.

4. The apparatus of claim 1, wherein the upper barrier comprises:
an upper barrier base; and
an upper barrier sidewall raising from the upper barrier base.

5. The apparatus of claim 1, wherein the upper barrier is impermeable to water.

6. The apparatus of claim 1, wherein the upper barrier comprises pores structurally configured to permit passage of liquid.

7. The apparatus of claim 1, wherein the lower barrier is liquid permeable.

8. The apparatus of claim 1, wherein the lower barrier is sealed to the sidewall.

9. The apparatus of claim 1, wherein the pre-shaped portion is concave.

10. The apparatus of claim 1, further comprising an additional injection zone disposed in at least one of the sidewall and the lid.

11. The apparatus of claim 1, wherein at least one of the injection zone and an additional injection zone is structurally configured to reseal after use.

12. The apparatus of claim 1, further comprising an additional evacuation zone disposed in at least one of the sidewall and the base.

13. The apparatus of claim 1, wherein at least one of the evacuation zone and an additional evacuation zone is structurally configured to reseal after use.

14. The apparatus of claim 1, wherein the lid is structurally configured to be removeable.

15. The apparatus of claim 1, wherein the injection zone is disposed between the lower barrier and the upper barrier.

16. The apparatus of claim 1, wherein at least one of the upper substance and the lower substance comprises a dissolvable ingredient.

17. The apparatus of claim 1, wherein at least one of the upper substance and the lower substance comprises creamed honey.

18. The apparatus of claim 1, wherein at least one of the upper substance and the lower substance comprises at least one of: tea, ground coffee, lemonade powder, flavored electrolyte powder, sugar, or powdered milk.

19. The apparatus of claim 1, wherein at least one of the upper substance and the lower substance comprises at least one of: crystalized honey, flavored syrup concentrate, corn syrup, artificial sweetener, or agave nectar.

20. The apparatus of claim 1, wherein the injection zone is structurally configured to be pierced with a lower force than the extraction zone.
